(19) United States
(12) Patent Application Publication
(10) Pub. No.: US 2008/0068756 A1
(43) Pub. Date: Mar. 20, 2008

(54) Head slider having recess at outflow end of front air bearing surface

(75) Inventor: Naozumi Tsuda, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 11/785,809

(22) Filed: Apr. 20, 2007

(30) Foreign Application Priority Data
Sep. 15, 2006 (JP) 2006-250929

(51) Int. Cl. G11B 21/20

(52) U.S. Cl. 360/235.5; 977/932

(57) ABSTRACT

A front rail is defined on the bottom surface at a position near the inflow end of the slider body. A front air bearing surface is defined on the top surface of the front rail. A rear rail defined on the bottom surface at a position near the outflow end of the slider body. A rear air bearing surface is defined on the top surface of the rear rail. A head element is embedded in the rear rail. A recess is formed at the outflow end of the front air bearing surface. The recess enables a fine adjustment of the flying height, the pitch angle and the roll angle of the head slider.

### BACKGROUND OF THE INVENTION

1. Field of the Invention

The present invention relates to a head slider incorporated in a storage medium drive such as a hard disk drive, HDD.

2. Description of the Prior Art

An electromagnetic transducer is mounted on a head slider in a hard disk drive for read/write of magnetic bit data, for example. The electromagnetic transducer keeps flying above the surface of the magnetic recording disk during read/write operations of magnetic bit data. The flying height of the head slider is set at approximately 20 nm, for example.

A hard disk drive is expected to have an increased recording density. The head slider should enjoy the flying height reduced to 10 nm approximately or below for such an increase in the recording density. Accordingly, the head slider is required to have an enhanced stability in the flying height and flying attitude. Change in the flying height and the flying attitude of the head slider causes contact or collision of the head slider against the magnetic recording disk. This often leads to damages to data recorded in the magnetic recording disk.

### SUMMARY OF THE INVENTION

It is accordingly an object of the present invention to provide a head slider having an enhanced stability in the flying height and the flying attitude.

According to a first aspect of the present invention, there is provided a head slider comprising: a slider body; a front rail defined on the bottom surface at a position near the inflow end of the slider body; a front air bearing surface defined on the top surface of the front rail; a rear rail defined on the bottom surface at a position near the outflow end of the slider body; a rear air bearing surface defined on the top surface of the rear rail; a head element embedded in the rear rail; and a recess formed at the outflow end of the front air bearing surface.

The recess enables a fine adjustment of the flying height, the pitch angle and the roll angle of the head slider. Optimization of the flying height, the pitch angle and the roll angle can thus be achieved in a relatively facilitated manner. This results in enhancement of stability in the flying height and the flying attitude of the head slider. The length of the recess maybe adjusted in the longitudinal direction of the slider body for the fine adjustment. The position of the recess may also be adjusted in the lateral direction of the slider body for the fine adjustment. The head slider may include at least one pair of recesses for the fine adjustment. The recess/recesses may be carved on the outflow end surface of the front rail.

The head slider can be utilized in a storage medium drive, for example. The storage medium drive may comprise: a slider body; a front rail defined on the bottom surface at a position near the inflow end of the slider body; a front air bearing surface defined on the top surface of the front rail; a rear rail defined on the bottom surface at a position near the outflow end of the slider body; a rear air bearing surface defined on the top surface of the rear rail; a head element embedded in the rear rail; and a recess formed at the outflow end of the front air bearing surface.

According to a second aspect of the present invention, there is provided a head slider comprising: a slider body; a front rail formed on the bottom surface at a position near the inflow end of the slider body; at least one pair of front air bearing surfaces defined on the top surface of the front rail; a rear rail defined on the bottom surface at a position near the outflow end of the slider body; a rear air bearing surface defined on the top surface of the rear rail; ahead element embedded in the rear rail; and a recess formed at the outflow end of at least one of the front air bearing surfaces.

The recess enables a fine adjustment of the flying height, the pitch angle and the roll angle of the head slider in the same manner as described above. Optimization of the flying height, the pitch angle and the roll angle can thus be achieved in a relatively facilitated manner. This results in enhancement of stability in the flying height and the flying attitude of the head slider. The length of the recess may be adjusted in the longitudinal direction of the slider body for the fine adjustment. The position of the recess may also be adjusted in the lateral direction of the slider body for the fine adjustment.

In this case, it is preferable that the recesses are formed at the front air bearing surfaces, respectively. The recesses enable a finer adjustment of the flying height, the pitch angle and the roll angle of the head slider. The recess/recesses may be carved on the outflow end surface of the front rail.

The head slider may further comprise at least one center rail extending from the outflow end surface of the front rail toward the outflow end of the head slider. In this case, the head slider includes a pair of center rails formed side by side. The center rails are respectively serves to generate a negative pressure behind the front rail for the individual front air bearing surfaces. The influence of the recesses can thus be differently adjusted. The head slider may have a pair of the center rail formed side by side.

The head slider may further comprise a groove formed in the front rail in a space between the front air bearing surfaces, the groove extending to reach the outflow end surface of the front rail. The groove significantly contributes to a fine adjustment of the flying height, the pitch angle and the roll angle of the head slider. The length of the groove may be adjusted in the longitudinal direction of the slider body for the adjustment.

The head slider may be utilized in a storage medium drive, for example. The storage medium drive may comprise: a slider body; a front rail defined on the bottom surface at a position near the inflow end of the slider body; at least one pair of front air bearing surfaces defined on the top surface of the front rail; a rear rail defined on the bottom surface at a position near the outflow end of the slider body; a rear air bearing surface defined on the top surface of the rear rail; ahead element embedded in the rear rail; and a recess formed at the outflow end of at least one of the front air bearing surfaces.

### BRIEF DESCRIPTION OF THE DRAWINGS

The above and other objects, features and advantages of the present invention will become apparent from the following description of the preferred embodiment in conjunction with the accompanying drawings, wherein:

FIG. 1 is a plan view schematically illustrating the inner structure of a hard disk drive, HDD, as an example of a storage medium drive according to the present invention;

FIG. 2 is an enlarged perspective view schematically illustrating a flying head slider according to an embodiment of the present invention;

FIG. 3 is an enlarged partial plan view of the bottom surface for illustrating a rear rail in detail;

FIG. 4 is a graph showing the influence of the length of a recess on the pitch angle of the flying head slider;

FIG. 5 is a graph showing the influence of the length of the recess on the roll angle of the flying head slider;

FIG. 6 is a graph showing the influence of the length of the recess on the flying height of the flying head slider;

FIG. 7 is a graph showing the influence of the position of the recess in the lateral direction on the pitch angle of the flying head slider;

FIG. 8 is a graph showing the influence of the position of the recess in the lateral direction on the roll angle of the flying head slider;

FIG. 9 is a graph showing the influence of the position of the recess in the lateral direction on the flying height of the flying head slider;

FIG. 10 is a graph showing the influence of the position of a center rail in the lateral direction on the pitch angle of the flying head slider;

FIG. 11 is a graph showing the influence of the position of the center rail in the lateral direction on the roll angle of the flying head slider;

FIG. 12 is a graph showing the influence of the position of the center rail in the lateral direction on the flying height of the flying head slider;

FIG. 13 is a graph showing the influence of the length of a groove on the pitch angle of the flying head slider;

FIG. 14 a graph showing the influence of the length of the groove on the roll angle of the flying head slider; and

FIG. 15 is a graph showing the influence of the length of the groove on the flying height of the flying head slider.

### DESCRIPTION OF THE PREFERRED EMBODIMENT

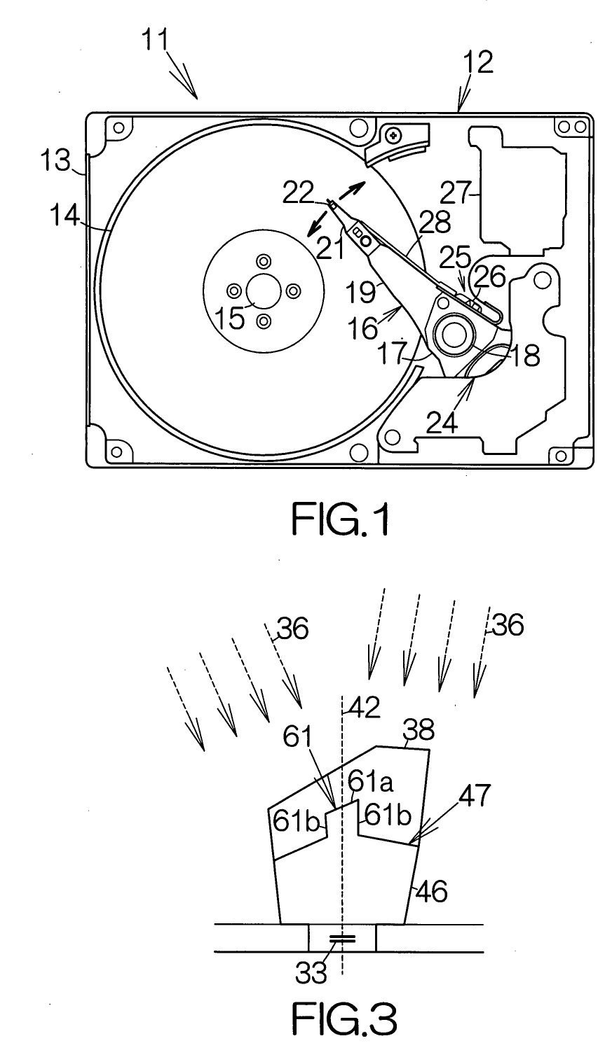

FIG. 1 schematically illustrates the inner structure of a hard disk drive, HDD, 11 as an example of a storage medium drive or a storage device according to the present invention. The hard disk drive 11 includes an enclosure 12 including a box-shaped base 13 and an enclosure cover, not shown. The base 13 defines an inner space in the form of a flat parallelepiped, for example. The base 13 may be made of a metallic material such as aluminum, for example. Molding process may be employed to form the base 13. The enclosure cover is coupled to the base 13 to close the opening of the base 13. An inner space is defined between the base 13 and the enclosure cover. Pressing process may be employed to form the enclosure cover out of a plate material, for example.

At least one magnetic recording disk 14 as a storage medium is enclosed in the enclosure 12. The magnetic recording disk or disks 14 are mounted on the driving shaft of a spindle motor 15. The spindle motor 15 drives the magnetic recording disk or disks 14 at a higher revolution speed such as 5,400 rpm, 7,200 rpm, 10,000 rpm, 15,000 rpm, or the like.

A carriage 16 is also enclosed in the enclosure 12. The carriage 16 includes a carriage block 17. The carriage block 17 is supported on a vertical support shaft 18 for relative rotation. Carriage arms 19 are defined in the carriage block 17. The carriage arms 19 are designed to extend in the horizontal direction from the vertical support shaft 18. The carriage block 17 may be made of aluminum, for example. Extrusion molding process may be employed to form the carriage block 17, for example.

A head suspension 21 is attached to the front or tip end of the individual carriage arm 19. The head suspension 21 is designed to extend forward from the carriage arm 19. A gimbal spring, not shown, is connected to the tip end of the individual head suspension 21. A flying head slider 22 is fixed to the surf ace of the gimbal spring. The gimbal spring allows the flying head slider 22 to change its attitude relative to the head suspension 21. A magnetic head or electromagnetic transducer is mounted on the flying head slider 22 as described later in detail.

When the magnetic recording disk 14 rotates, the flying head slider 22 is allowed to receive an airflow generated along the rotating magnetic recording disk 14. The airflow serves to generate a positive pressure or a lift as well as a negative pressure on the flying head slider 22. The flying head slider 22 is thus allowed to keep f lying above the surface of the magnetic recording disk 14 during the rotation of the magnetic recording disk 14 at a higher stability established by the balance between the urging force of the head suspension 21 and the combination of the lift and the negative pressure.

When the carriage 16 swings around the vertical support shaft 18 during the flight of the flying head slider 22, the flying head slider 22 is allowed to move along the radial direction of the magnetic recording disk 14. The electromagnetic transducer on the flying head slider 22 is thus allowed to cross the data zone defined between the innermost and outermost recording tracks. The electromagnetic transducer on the flying head slider 22 is positioned right above a target recording track on the magnetic recording disk 14.

A power source or voice coil motor, VCM, 24 is coupled to the carriage block 17. The voice coil motor 24 serves to drive the carriage block 17 around the vertical support shaft 18. The rotation of the carriage block 17 allows the carriage arms 19 and the head suspensions 21 to swing.

As is apparent from FIG. 1, a flexible printed circuit board unit 25 is located on the carriage block 17. The flexible printed circuit board unit 25 includes a head IC (integrated circuit) 26 mounted on a flexible printed wiring board. The head IC 26 is designed to supply the read element of the electromagnetic transducer with a sensing current when the magnetic bit data is to be read. The head IC 26 is also designed to supply the write element of the electromagnetic transducer with a writing current when the magnetic bit data is to be written. A small-sized circuit board 27 is located within the inner space of the enclosure 12. A printed wiring board, not shown, is attached to the back surface of the bottom plate of the base 13. The small-sized circuit board 27 or the printed wiring board are designed to supply the head IC 26 with the sensing current and the writing current.

A flexible printed wiring board 28 is utilized to supply the sensing current and writing current. The flexible printed wiring board 28 is related to the individual flying head slider 22. The flexible printed wiring board 28 includes a metallic thin film made of stainless steel or the like, an insulating layer, an electrically-conductive layer and a protection layer. The insulating layer, the electrically-conductive layer and the protection layer are overlaid on the metallic thin film in this sequence. The electrically-conductive layer includes a wiring pattern, not shown, extending along the flexible printed wiring board 28. The electrically-conductive layer may be made of an electrically-conductive material such as copper. The insulating layer and the protection layer may be made of a resin material such as polyimide resin.

The wiring pattern on the flexible printed wiring board 28 is connected to the flying head slider 22. An adhesive is utilized to attach the flexible printed wiring board 28 on the head suspension 21, for example. The flexible printed wiring board 28 extends backward along the side of the carriage arm 19 from the head suspension 21. The rear end of the flexible printed wiring board 28 is connected to the flexible printed circuit board unit 25. The wiring pattern on the flexible printed wiring board 28 is connected to a wiring pattern, not shown, on the flexible printed circuit board unit 25. Electrical connection is in this manner established between the flying head slider 22 and the flexible printed circuit board unit 25.

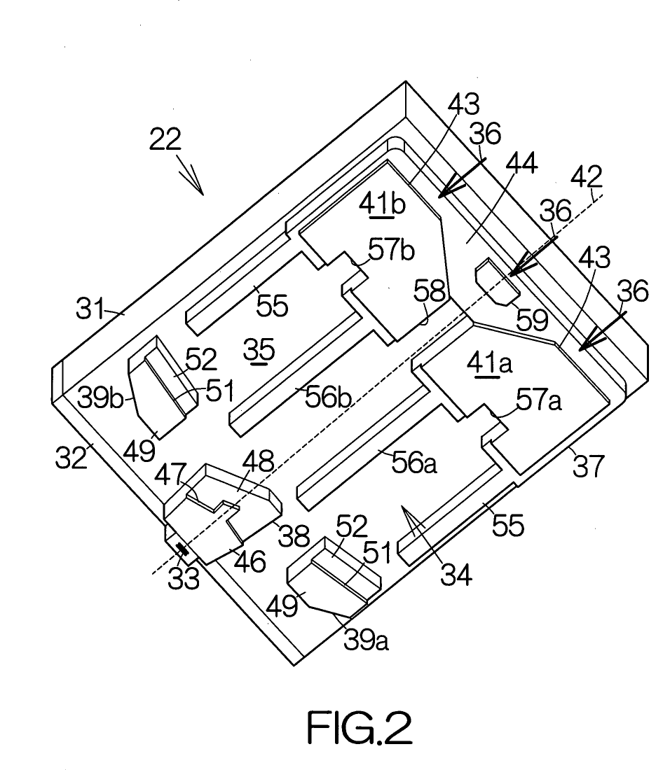

FIG. 2 illustrates a specific example of the flying head slider 22. The flying head slider 22 includes a slider body 31 in the form of a flat parallelepiped, for example. A head protection film 32 is overlaid on the outflow or trailing end of the slider body 31. The aforementioned magnetic head or electromagnetic transducer 33 is incorporated in the head protection film 32. The slider body 31 is made of a hard material such as Al₂O₃—Tic. The head protection film 32 is made of a soft material such as Al₂O₃ (alumina). A medium-opposed surface or bottom surface 34 is defined over the slider body 31 so as to face the magnetic recording disk 14 at a distance. A flat base surface 35 as a reference surface is defined on the bottom surface 34. When the magnetic recording disk 14 rotates, airflow 36 acts on the bottom surface 34 in the direction from the front end toward the rear end of the slider body 31.

A front rail 37 is formed on the bottom surface 34. The front rail 37 stands upright from the base surface 35 near the inflow end of the base surface 35. The front rail 37 extends on the base surface 35 at a predetermined thickness ranging from 1.5 μm to 2.0 μm approximately, for example. The front rail 37 extends along the inflow end of the base surface 35 in the lateral direction of the slider body 31.

A rear rail 38 is likewise formed on the bottom surface 34. The rear rail 38 stands upright from the base surface 35 near the outflow end of the base surface 35. The rear rail 38 is located on the intermediate position in the lateral direction of the slider body 31. The rear rail 38 extends on the base surface 35 at the thickness equal to that of the front rail 37. The rear rail 38 extends toward the outflow end of the base 35.

A pair of auxiliary rear rails 39a, 39b is likewise formed on the bottom surface 34. The auxiliary rear rails 39a, 39b stand upright from the base surface 35 near the outflow end of the base surface 35. The auxiliary rear rails 39a, 39b are respectively located along the sides of the babe surface 35. The auxiliary rear rails 39a, 39b are thus spaced from each other in the lateral direction of the slider body 31. The rear rail 38 is located between the auxiliary rear rails 39a, 39b.

A pair of front air bearing surfaces 41a, 41b is defined side by side on the top surface of the front rail 37. The front air bearing surfaces 41a, 41b are spaced from each other in the lateral direction of the slider body 31. The space extends between the front air bearing surfaces 41a, 41b along a longitudinal centerline 42. The longitudinal centerline 42 serves to connect the middle of the inflow end in the lateral direction of the slider body 31 to the middle of the outflow end in the lateral direction of the slider body 31. A step 43 is formed at the inflow end of each of the front air bearing surfaces 41a, 41b. A low level surface 44 is defined on the top surface of the front rail 37 at a position upstream of the front air bearing surfaces 41a, 41b. The low level surface 44 extends at a level lower than that of the front air bearing surfaces 41a, 41b.

A rear air bearing surface 46 is likewise defined on the top surface of the rear rail 38. The rear air bearing surface 46 extends along the longitudinal centerline 42. A step 47 is formed at the inflow end of the rear air bearing surface 46. A low level surface 48 is defined on the top surface of the rear rail 38 at a position upstream of the rear air bearing surface 46. The low level surface 48 extends at a level lower than that of the rear air bearing surface 46.

An auxiliary air bearing surface 49 is likewise defined on the top surface of each of the auxiliary rear rails 39a, 39b. The auxiliary air bearing surfaces 49 are respectively located along the sides of the base surface 35. The auxiliary air bearing surfaces 49 are thus spaced from each other in the lateral direction of the slider body 31. The rear air bearing surface 46 is located in a space between the auxiliary air bearing surfaces 49. A step 51 is formed at the inflow end of the individual auxiliary air bearing surface 49. A low level surface 52 is defined on the top surface of each of the auxiliary rear rails 39a, 39b at a position upstream of the auxiliary air bearing surface 49. The low level surface 52 extends at a level lower than that of the auxiliary air bearing surface 49.

The aforementioned electromagnetic transducer 33 is embedded in the rear rail 38. The electromagnetic transducer 33 includes a read element and a write element. The write element may include a thin film magnetic head designed to write magnetic bit data onto the magnetic recording disk 14 by utilizing a magnetic field induced at a thin film coil pattern. The read element may include a giant magnetoresistive (GMR) element or a tunnel-junction magnetoresistive (TMR) element designed to discriminate magnetic bit data on the magnetic recording disk 14 by utilizing variation in the electric resistance of a spin valve film or a tunnel-junction film, for example. The electromagnetic transducer 33 has a read gap and a write gap exposed near the outflow end of the rear air bearing surface 46. A heater, not shown, may also be incorporated in the rear rail 38 at a position adjacent to the electromagnetic transducer 33. The heater generates heat for expansion of the electromagnetic transducer 32. The flying height of the read gap and the write gap can be adjusted depending on the expansion of the electromagnetic transducer 32.

A protection film, not shown, is formed on the surface of the slider body 31 at each of the front air bearing surfaces 41a, 41b, the rear air bearing surface 46 and the auxiliary air bearing surfaces 49, 49, for example. The protection film extends over the read gap and the write gap in the rear air bearing surface 46. The protection layer may be made of diamond-like-carbon (DLC), for example.

The bottom surface 34 of the flying head slider 22 is designed to receive the airflow 36 generated along the rotating magnetic recording disk 14. The steps 43, 47, 51, 51 serve to generate a larger positive pressure or lift at the air bearing surfaces 41a, 41b, 46, 49, 49, respectively. Moreover, a relatively larger negative pressure is induced behind the front rail 37 or near the in flow end of the base surface 35. The negative pressure is balanced with the lift so as to stably establish the flying attitude of the flying head slider 22.

A larger positive pressure or lift is generated at the front air bearing surfaces 41a, 41b as compared with the rear air bearing surface 46 and the auxiliary air bearing surfaces 49, 49 in the flying head slider 22. When the slider body 31 flies above the surface of the magnetic recording disk 14, the slider body 31 can be kept at an inclined attitude defined by a pitch angle α. The term “pitch angle” is used to define an inclined angle in the longitudinal direction of the slider body 31 along the direction of the airflow 36. A lift is equally generated in the pair of front air bearing surfaces 41, 41b as well as in the pair of auxiliary air bearing surfaces 49, 49. This results in a significant suppression in change in a roll angles of the flying head slider 22 during flight. Specifically, the slider body 31 is kept at a predetermined roll angle β. The auxiliary air bearing surfaces 49 are thus prevented from contact or collision against the magnetic recording disk 14. The term “roll angle” is used to define an inclined angle in the lateral direction of the slider body 31 perpendicular to the direction of the airflow 36.

A pair of side rails 55, 55 is also formed on the bottom surface 34 of the slider body 31. The side rails 55, 55 stand upright from the base surface 35 of the slier body 31 at positions downstream of the front rail 37. The side rails 55 respectively extend along the sides of the base surface 35 in parallel with the longitudinal centerline 42. The inflow ends of the side rails 55, 55 are connected to the outflow end surface of the front rail 37 at the opposite ends of the front rail 37 in the lateral direction, respectively. The side rails 55 serve to prevent airflow from running into a apace behind the front rail 37 around the opposite ends of the front rail 37 during the flight of the flying head slider 22. The airflow 36 is thus allowed to spread in a direction perpendicular to the bottom surface 34 behind the front rail 37 after flowing along the front air bearing surfaces 41a, 41b. Such a rapid spread of airflow leads to generation of the negative pressure. The individual side rail 55 defines the top surface extending at the level equal to that of the low level surface 44 of the front rail 37.

A pair of center rails 56a, 56b are likewise formed side by side on the bottom surface 34 of the slider body 31. The center rails 56a, 56b stand upright from the base surface 35 of the slider body 31 at positions downstream of the front rail 37. The center rails 56a, 56b are located in a space between the side rails 55, 55. The center rails 56a, 56b respectively extend at positions adjacent to the longitudinal centerline 42 in parallel with the longitudinal centerline 42. The inflow ends of the center rail 56a, 56b are connected to the outflow end surface of the front rail 37. The center rails 56a, 56b serve to guide the airflow 36 toward the rear air bearing surface 46. The center rails 56a, 56b also serve to guide the airflow 36 toward the auxiliary air bearing surfaces 49 in corporate with the corresponding side rails 55, respectively. Each of the center rails 56a, 56b defines the top surface extending at the level equal to that of the low level surface 44 of the front rail 37.

Recesses 57a, 57b are respectively formed in the outflow ends of the front air bearing surfaces 41, 41b. The recess 57a is located between the center rail 56a and the corresponding side rail 55 while the recess 57b is located between the center rail 56b and the corresponding side rail 55. The recesses 57a, 57b are carved in the outflow end surface of the front rail 37. The recesses 57a, 57b thus reach the base surface 35. The recesses 57a, 57b enable a fine adjustment of the flying height, the pitch angle α and the roll angle β of the flying head slider 22 as described later in detail.

A groove 58 is formed in the outflow end surface of the front rail 37 between the front air bearing surfaces 41, 41b. The groove 58 serves to shift the outflow end of the front rail 37 toward the inflow end between the front air bearing surfaces 41, 41b. The groove 58 enables a fine adjustment of the flying height and the pitch angle α of the flying head slider 22 as described later.

A protuberance 59 is formed on the low level surface 44 of the front rail 37 at a position upstream of the inflow end of the groove 58. The surface of the protuberance 59 may be located at the level equal to that of the surfaces of the front air bearing surfaces 41a, 41b, for example. A step is thus formed at the inflow end of the protuberance 59. When the airflow 36 runs against the step, dust is eliminated from the airflow 36. Dust is prevented from entering the groove 58 in this manner.

As shown in FIG. 3, a protruding portion 61 is formed in the step 47 of the rear rail 37. The protruding portion 61 defines an inflow end 61a and a pair of side edges 61b, 61b. The inflow end 61a extends in parallel with the inflow end of the rear rail 38. The edges 61b, 61b respectively extend in parallel with the longitudinal centerline 42 from the opposite ends of the inflow end 61a in the lateral direction toward the outflow end of the base surface 35. The outflow ends of the edges 61b are connected to the inflow end of the rear air bearing surface 46. The inflow end of the rear air bearing surface 46 gets closer to the outflow end of the base surface 35 at a position getting distanced from the longitudinal centerline 42. The step 47 enables generation of a constant positive pressure or lift at the rear air bearing surface 46 regardless of change in the direction of the airflow 36 relative to the rear air bearing surface 46.

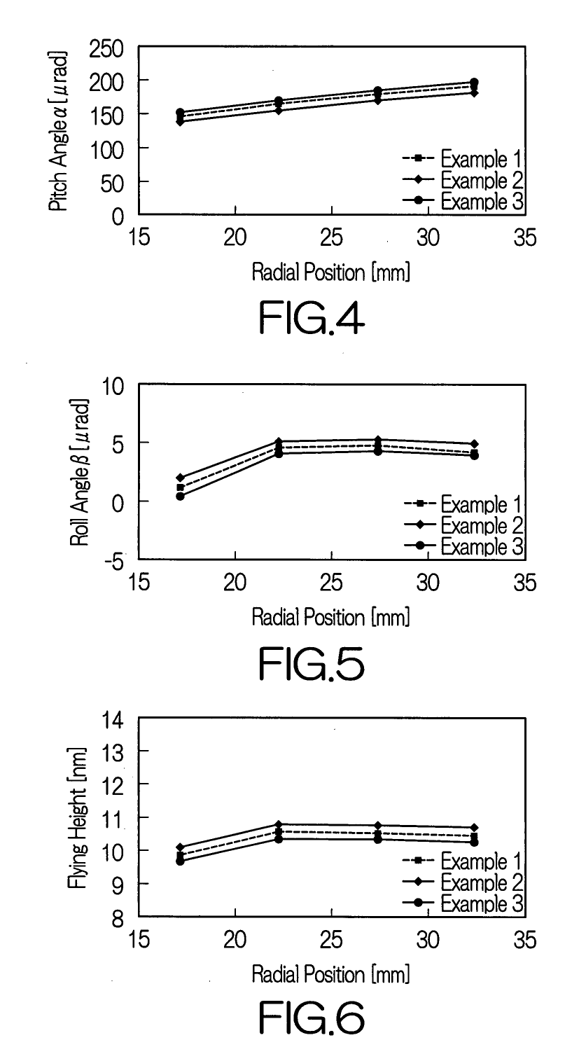

The inventor has observed the influence of the recesses 57a, 57b and the groove 58. A computer simulation was utilized for the observation. The inventor first changed the length of the recesses 57a, 57b in parallel with the longitudinal centerline 42. The length of the recesses 57a, 57b is increased in the specific example 2 of the flying head slider 22 as compared with the specific example 1. The length of the recesses 57a, 57b is reduced in the specific example 3 as compared with the specific example 1. It has been confirmed that increase in the length of the recesses 57a, 57b leads to reduction in the pitch angle α, as is apparent from FIG. 4. It has also been confirmed that the roll angle β and the flying height are increased as shown in FIGS. 5 and 6. It has also been confirmed that the amount of change in the roll angle β is significantly smaller as compared with the amount of change in the pitch angle α. It has also been confirmed that change in the flying height is minimized. It has also been confirmed that changes in the flying height, the pitch angle α and the roll angle β depend on the position in the radial direction of the magnetic recording disk 14 in any of the specific examples 1, 2 and 3. It should be noted that the recesses 57a, 57b are forced to have the same width and the same positions in the lateral direction in any of the specific examples 1, 2 and 3 during the observation. The groove 58 and the center rails 56a, 56b are also forced to have the same dimensions and the same positions in any of the specific examples 1, 2 and 3.

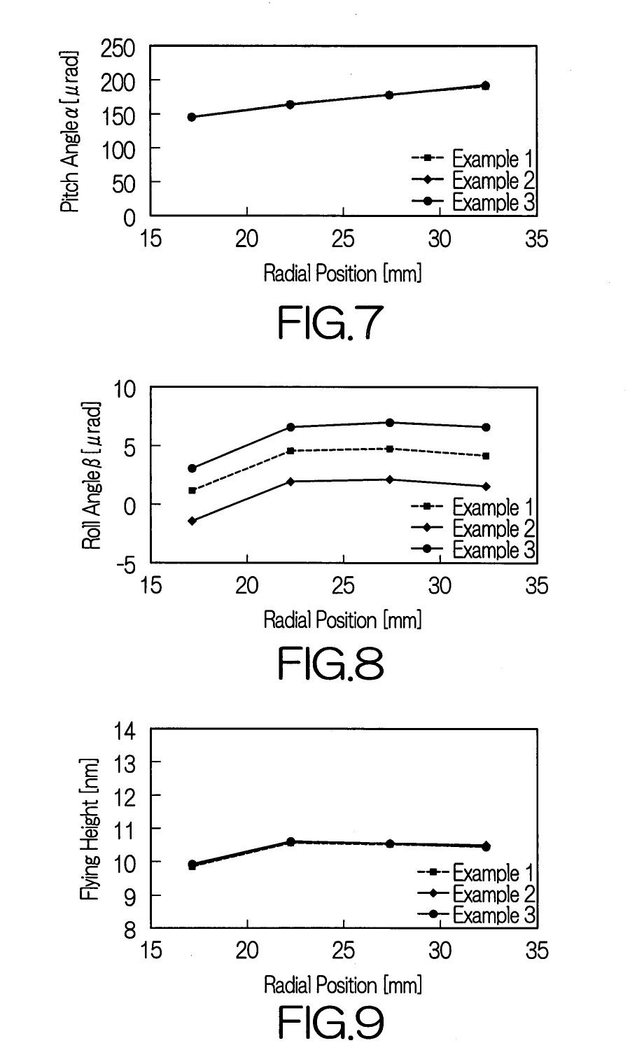

Next, the inventor changed the positions of the recesses 57a, 57b in the lateral direction of the slider body 31 without changing the relative position between the recesses 57a, 57b. The recesses 57a, 57b were shifted toward the center of the magnetic recording disk 14 in the specific example 2 as compared with the specific example 1. The recesses 57a, 57b were shifted toward the outer periphery of the magnetic recording disk 14 in the specific example 3 as compared with the specific example 1. As shown in FIGS. 7 to 9, it has been confirmed that the roll angle β is reduced when the recesses 57a, 57b are located at a position closer to the center of the magnetic recording disk 14. It has also been confirmed that the pitch angle α and the flying height are kept constant regardless of a change in the roll angle β in this case. It has also been confirmed that changes in the flying height, the pitch angle α and the roll angle β depend on the position in the radial direction of the magnetic recording disk 14 in any of the specific examples 1, 2 and 3. It should be noted that the recesses 57a, 57b are forced to have the same width and the same positions in the lateral direction in any of the specific examples 1, 2 and 3 during the observation. The groove 58 and the center rails 56a, 56b are also forced to have the same dimensions and the same positions in any of the specific examples 1, 2 and 3.

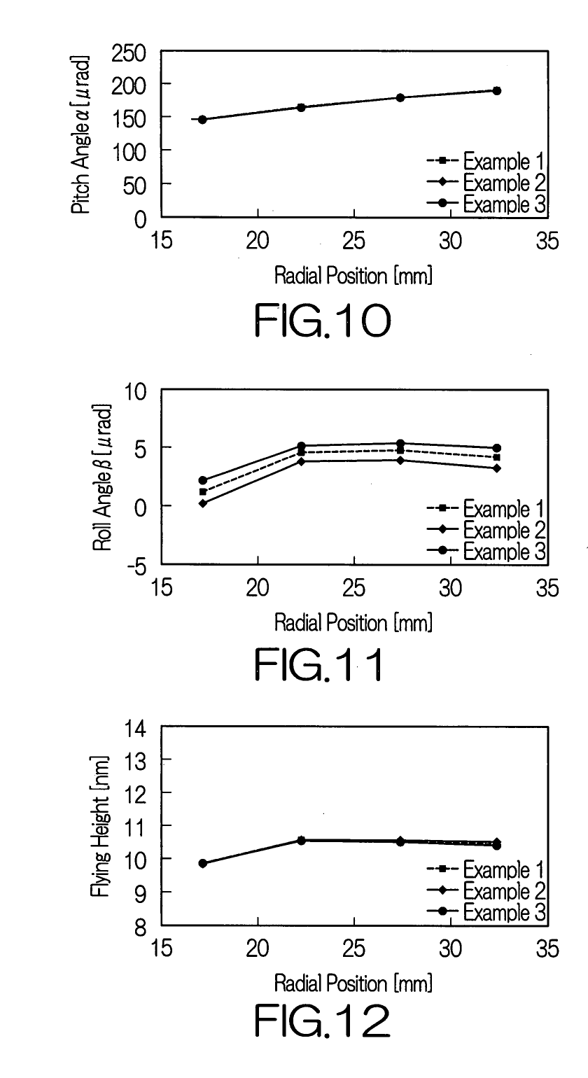

Next, the inventor changed the positions of the center rails 56a, 56b in the lateral direction of the slider body 31 without changing the relative position between the center rails 56a, 56b. The center rails 56a, 56b were shifted toward the center of the magnetic recording disk 14 in the specific example 2 as compared with the specific example 1. The center rails 56a, 56b were shifted toward the outer periphery of the magnetic recording disk 14 in the specific example 3 as compared with the specific example 1. As shown in FIGS. 10 to 12, it has been confirmed that the roll angle β is reduced when the center rails 56a, 56b are located at a position closer to the center of the magnetic recording disk 14. It has also been confirmed that the pitch angle α and the flying height are kept constant regardless of a change in the roll angle β. It has also been confirmed that change in the pitch angle α is smaller as compared with the aforementioned observation where the positions of the recesses 57a, 57b were changed. It has also been confirmed that changes in the flying height, the pitch angle α and the roll angle β depend on the position in the radial direction of the magnetic recording disk 14 in any of the specific examples 1, 2 and 3. It should be noted that recesses 57a, 57b and the groove 58 are forced to have the same width and the same positions in the lateral direction in any of the specific examples 1, 2 and 3 during the observation.

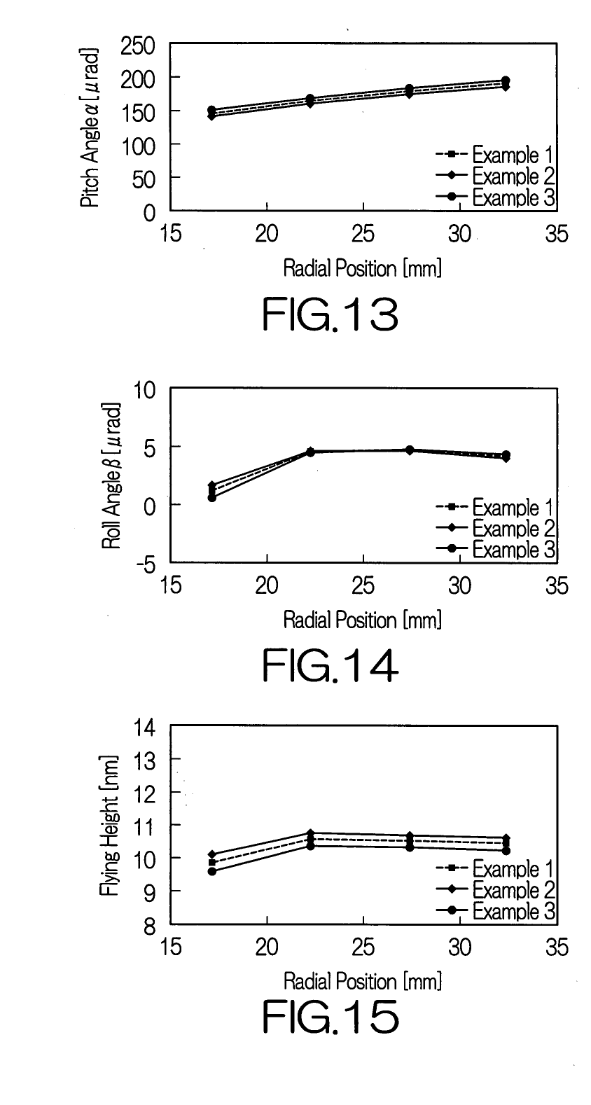

Next, the inventor changed the dimension of the groove 58 along the longitudinal direction 42. The dimension of the groove 58 was increased in the specific example 2 as compared with the specific example 1. The dimension of the groove 58 was reduced in the specific example 3 as compared with the specific example 1. As shown in FIGS. 13 to 15, it has been confirmed that an increased length of the groove 58 leads to reduction in the pitch angle α. It has also been confirmed that the roll angle β and the flying height are increased. It has also been confirmed that the amount of change in the roll angle β is significantly smaller as compared with the amount of change in the pitch angle α. It has also been confirmed that a change in the flying height is minimized. It has also been confirmed that changes in the flying height, the pitch angle α and the roll angle β depend on the position in the radial direction of the magnetic recording disk 14 in any of the specific examples 1, 2 and 3. It should be noted that the groove 58 is forced to have the same width and the same positions in the lateral direction in any of the specific examples 1, 2 and 3 during the observation. The recesses 57a, 57b and the center rails 56a, 56b are also forced to have the same dimensions and the same positions in any of the specific examples 1, 2 and 3.

What is claimed is:

1. A head slider comprising:
a slider body;
a front rail defined on a bottom surface at a position near an inflow end of the slider body;
a front air bearing surface defined on a top surface of the front rail;
a rear rail defined on the bottom surface at a position near an outflow end of the slider body;
a rear air bearing surface defined on a top surface of the rear rail;
a head element embedded in the rear rail; and
a recess formed at an outflow end of the front air bearing surface.

2. The head slider according to claim 1, wherein at least a pair of recesses is formed at the outflow end of the front air bearing surface.

3. The head slider according to claim 1, wherein the recess is carved on an outflow end surface of the front rail.

4. A storage medium drive comprising the head slider according to claim 1.

5. A head slider comprising:
a slider body;
a front rail formed on a bottom surface at a position near an inflow end of the slider body;
at least a pair of front air bearing surfaces defined on a top surface of the front rail;
a rear rail defined on the bottom surface at a position near an outflow end of the slider body;
a rear air bearing surface defined on a top surface of the rear rail;
a head element embedded in the rear rail; and
a recess formed at an outflow end of at least one of the front air bearing surfaces.

6. The head slider according to claim 5, wherein the recesses are respectively formed at the front air bearing surfaces.

7. The head slider according to claim 6, wherein the recesses are carved on an outflow end surface of the front rail.

8. The head slider according to claim 5, further comprising at least one center rail extending from an outflow end surface of the front rail toward the outflow end of the slider body.

9. The head slider according to claim 8, wherein a pair of the center rails is formed side by side.

10. The head slider according to claim 9, wherein a groove is formed in the front rail in a space between the front air bearing surfaces, said groove extending to reach the outflow end surface of the front rail.

11. A storage medium drive comprising a head slider according to claim 5.
